(19) United States
(12) Patent Application Publication
(10) Pub. No.: US 2014/0164366 A1
(43) Pub. Date: Jun. 12, 2014

(54) FLAT BOOK TO RICH BOOK CONVERSION IN E-READERS

(71) Applicant: MICROSOFT CORPORATION, Redmond, WA (US)

(72) Inventors: Raman Narayanan, Seattle, WA (US); Ming Liu, Bellevue, WA (US); Wei Zeng, Sammamish, WA (US); Radoslav Nickolov, Seattle, WA (US); Aleksandr Gil, Redmond, WA (US)

(73) Assignee: Microsoft Corporation, Redmond, WA (US)

(21) Appl. No.: 13/712,372

(22) Filed: Dec. 12, 2012

(51) Int. Cl. G06F 17/30

(52) U.S. Cl. CPC G06F 17/3053
USPC 707/723

(57) ABSTRACT

Flat content (or flat book) is converted to rich content (or a rich book) in an e-reader environment through key term identification, context-based search using identified key terms, ranking of search results, and comparison of the ranked search results against a predefined threshold, customizable by a user or an administrator. Textual, graphic, audio, video, and comparable objects from search results above the predefined threshold may be augmented in suitable locations within the flat content such as interactive text, audio/video object, images, additional text, or other interactive elements.

### BACKGROUND

Mobile computing has transformed media consumption across markets. Miniaturization across product generations has enabled more functionality to be accomplished by smaller devices. A modern smartphone has more computing capacity than a desktop computer a few years ago. Mature product processes have also enabled advances in technology to be integrated to automated production of mobile devices seamlessly. Extensive automation has led to inexpensive components. Inexpensive components have enabled manufacturing of inexpensive mobile devices providing functionality on the go.

Recently, content has been making an accelerated march towards digital. Professionally published books and magazines are the most recent segment moving to digital domain with a variety of reader devices and platforms offering different aspects of user experience. Providers of e-reading services aim for compelling devices, satisfying reading experiences, rich catalog of digitized content with an easy commerce experience, a walled backend increasingly capable of hosting multiple content types, and early features in annotations and sharing features. However, majority of content is typically available in “flat” format (without any substantial interactivity capability) with some “rich” content (higher degree of interactivity for the user) being made available at higher cost. Given the vast universe of literary content, having users either wait until rich content is created professionally in sufficient numbers and/or having them pay a higher price for rich content is against the goal of enhanced user experience with e-readers.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to enabling conversion of less interactive “flat” content to much more interactive “rich” content in an e-reader platform. Flat books—documents with mostly static content—may be pre-processed by an e-reader application or service to be converted into rich books with a set of enhanced e-reader capabilities. Using context based search capabilities, key terms may be determined, search results ranked, and those above a predefined threshold selected for augmentation into the book. Images, audio/video objects, interactive objects, and comparable ones may be inserted and the book stored in an e-reader default format.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 illustrates an example flat book to rich book conversion in an e-reader service according to some embodiments;

FIG. 2 illustrates an example flat book to rich book conversion in a local e-reader application according to other embodiments;

FIG. 3 illustrates an example flat content presented in an e-reader;

FIG. 4 illustrates an example rich content presented in an e-reader according to embodiments;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of converting flat content to rich content in an e-reader environment according to embodiments.

### DETAILED DESCRIPTION

As briefly described above, less interactive “flat” content may be converted to much more interactive “rich” content in an e-reader platform using context based search capabilities, key term based searches, and augmentation into the flat book.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present disclosure is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable hardware media.

Throughout this specification, the term “platform” may be a combination of software and hardware components for providing flat to rich content in an e-reader application. Examples of platforms include, but are not limited to, a hosted service executed over a plurality of servers, an application executed on a single computing device, and comparable systems. The term “server” generally refers to a computing device executing one or more software programs typically in a networked environment. More detail on these technologies and example operations is provided below.

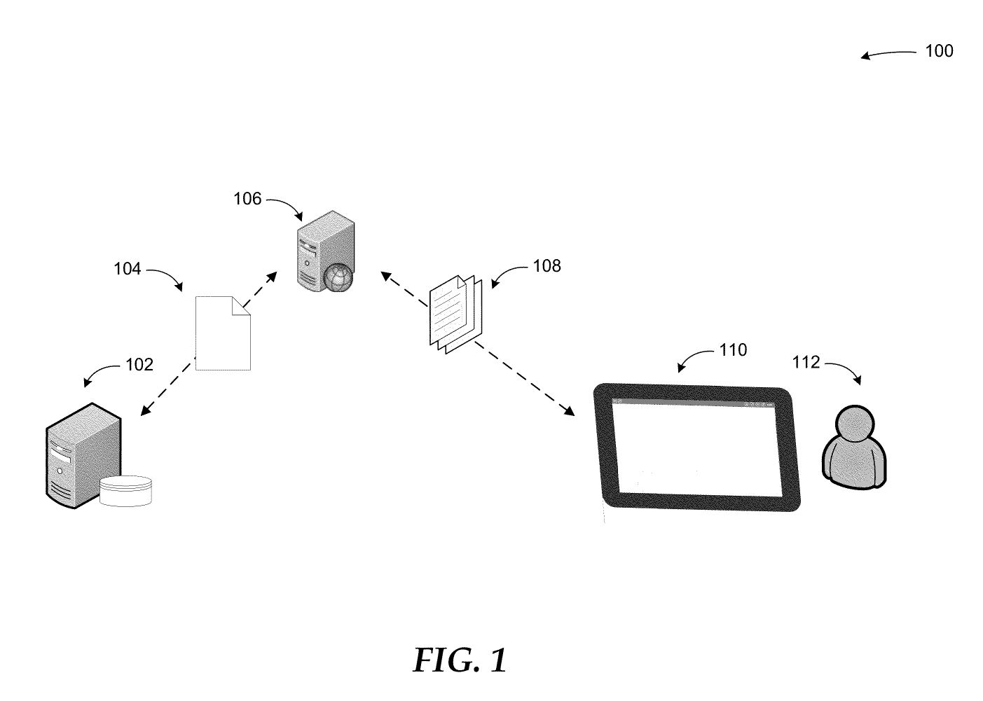

FIG. 1 illustrates an example flat book to rich book conversion in an e-reader service according to some embodiments. The components and environments shown in diagram 100 are for illustration purposes. Embodiments may be implemented in various local, networked, cloud-based and similar computing environments employing a variety of computing devices and systems, hardware and software.

An “e-reader” device such as a tablet 110 may host an application providing content to a user 112. Such an application may be called an e-reader application, which may be a locally installed and executed application receiving content (e.g., e-books, documents, etc.) through wired or wireless networks. The e-reader application may also be a hosted service provided by one or more servers (e.g., server 108) and accessed by a user through the e-reader device (e.g., tablet 110). Content may be any type of consumable data including but not exclusive to text, audio, video, graphic, etc. Content may also include media combinations presented in a standardized format (i.e.: a web page.) Content may be provided by a content server 102 hosting the content for consumption by services and devices.

An e-reader application according to embodiments may present content such as an e-book, a magazine article, a newspaper, or even a personal document to user 112 through tablet device 110 and enable enrichment of user experience through context based searches, interactivity, note taking, and comparable features.

Conventional text-based content, also referred to as flat books—documents with mostly static content—may be presented through server 106 to e-reader application on tablet 110 and read by the user 112. Flat book 104 representing a static content may be received from content server 102 at server 106 and converted to a rich book 108 according to some embodiments prior to being provided to the user 112 through the e-reader application on tablet 110.

The conversion may include pre-processing to augment the content with a set of enhanced e-reader capabilities. For example, context based search capabilities may be taken advantage of using key terms determined within the content. The key terms may be determined from terms within a predefined vicinity of a key term, a title of displayed content, and a type of displayed content. Search results may be ranked and those above a predefined threshold selected for augmentation into the rich book 108. In addition images, audio/video objects, interactive objects, etc. may be inserted and the rich book 108 stored in a default format such as EPUB or HTML.

Embodiments are not limited to implementation in a tablet 110 as user end device. In addition to touch or gesture enabled interactions, other input mechanisms such as standard mouse and keyboard interface, gyroscopic input devices, eye-tracking, and similar inputs may also be employed. In some examples, the reader service may convert flat books to rich books and make available to multiple users. In other examples, the e-reader application may perform the conversion for individual users based on user preferences, etc. as discussed below.

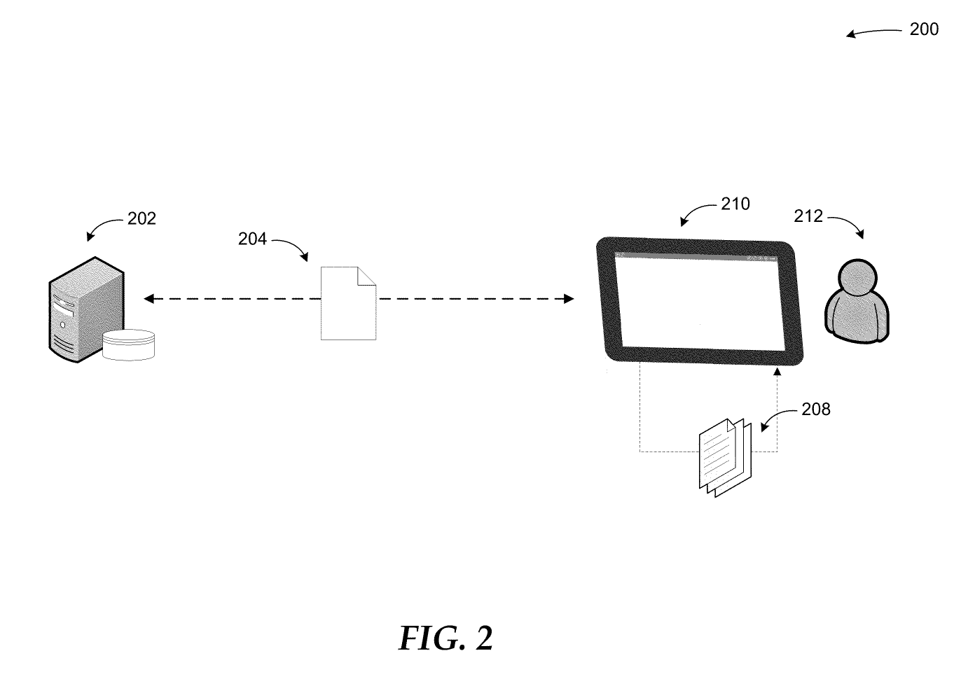

FIG. 2 illustrates an example flat book to rich book conversion in a local e-reader application according to other embodiments. Diagram 200 displays a local e-reader application based system as an alternative to the example architecture described in FIG. 1.

In the example configuration of diagram 200, the flat book 207 is provided from the content server 202 to the e-reader application executed on tablet 210 directly. The e-reader application may perform the conversion using context based search and augmentation. In the conversion process, the e-reader application may utilize one or more search engines and rank the results for augmentation into the rich book 208 or use the ranked results from a search engine directly in augmenting the contents of the flat book 204 with auxiliary information including textual, graphic, audio, video, etc. data.

Flat book and rich book as used herein refer to relatively static, non-interactive content and dynamic, interactive content, respectively. Such content may be in an e-reader book format, an article, a document, or other comparable content.

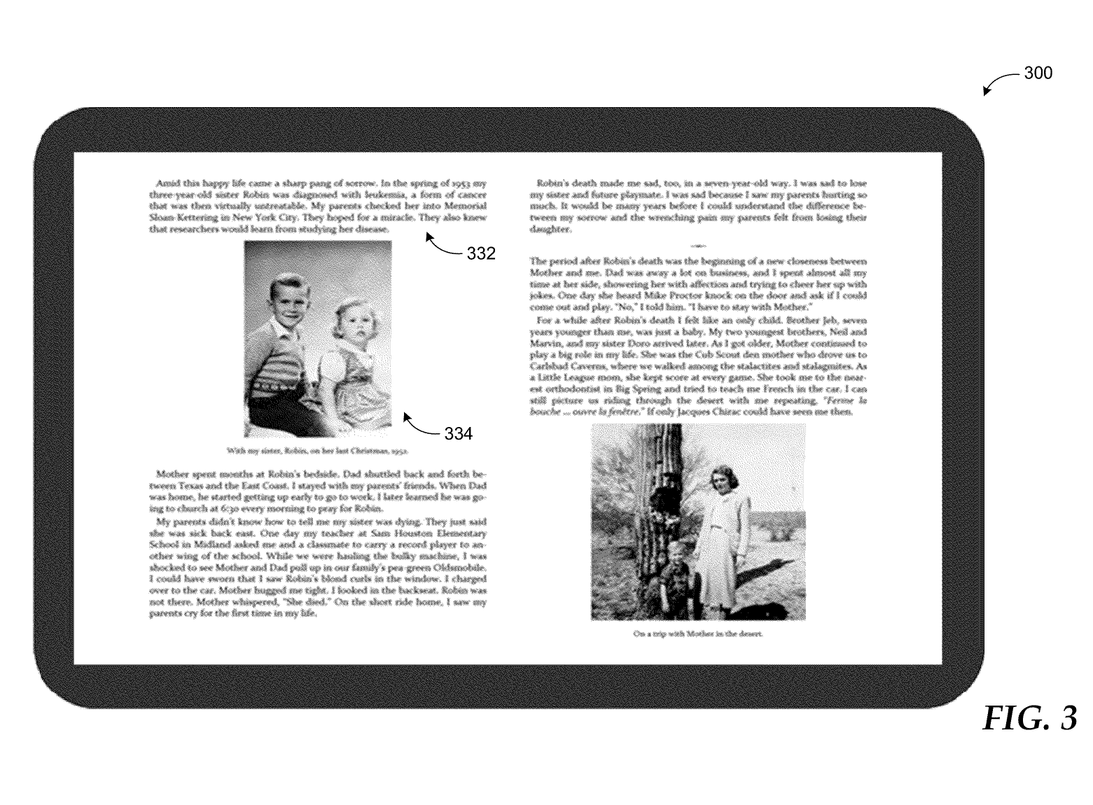

FIG. 3 illustrates an example flat content presented in an e-reader. Flat content is used to describe relatively static, non-interactive content. As shown in diagram 300, flat content may be a conventional book or article content, for example, with mostly textual data 332 and, in some cases, images 334 or graphics inserted between the textual data.

As mostly static data, flat content may be limited to standard reading experience without enhanced interaction (e.g., only limited to page-based navigation). In some cases, the textual data may enable basic searches such as word searches, but further capabilities may not be available restricting user experience through the e-reader.

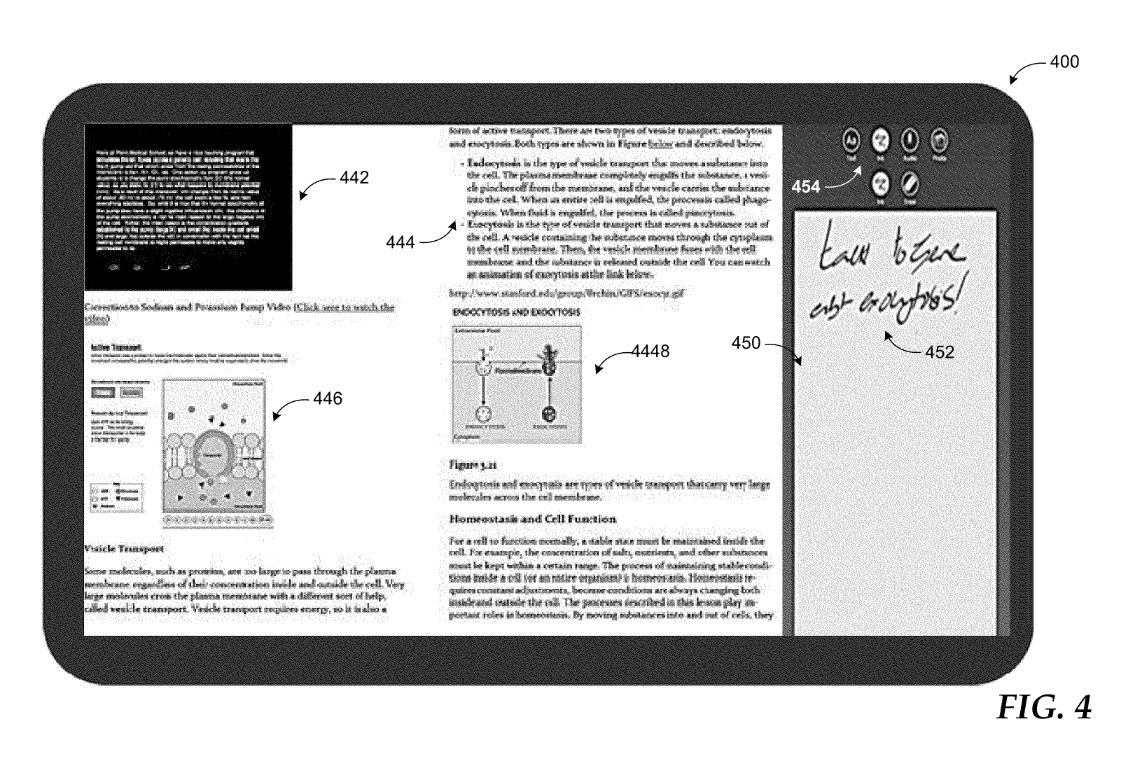

FIG. 4 illustrates an example rich content presented in an e-reader according to embodiments. Diagram 400 shows an e-reader application user interface featuring various enhanced capabilities associated with rich content enriching user experience.

As discussed previously, a conversion of a flat content (or flat book) may begin with key term identification, followed by a context-based search using those key terms. Search results may then be ranked and compared against a predefined threshold, customizable by a user or an administrator. Textual, graphic, audio, video, and comparable objects from search results above the predefined threshold may be augmented in suitable locations within the flat content such as interactive text (442), video object 446, and colored interactive image 448 within the textual data 444.

In addition to the augmentation of the flat content with search-based objects, additional interactivity features such as note taking capability (452) with notes being anchored with the text flow and entered and/or displayed on the content itself or on a special view pane 450. Further interactivity features may include local or web-based searches, sharing of content and/or notes, and comparable actions. These features may be enabled through controls 454 or through inference-based actions (such as activation of search upon highlighting of a portion of displayed content, etc.).

Flat books may be in a variety of formats (e.g., PDF, DOC, HTML). Context-based results from identified key terms may be ranked based on default/customizable rules. For example, a particular user or user group's interests may be taken into account when ranking the search results (e.g., “A Midsummer Night's Dream” may be converted using one set of search results for scholars, another set for high school students, and yet another set for children. The first set may focus on scholarly articles, maps of locations, references to libraries, etc. The second set may focus on explanations, dictionary functionality, tests, etc. The third set may focus on pictures, animations, etc.).

The converted book may not only have additional native functionality (various objects), but also interactable through the full functionality of the e-reader such as inline note taking, inking, snippets, layout reflow upon device change, context based look-up, etc.

Some additional features enhancing user experience may include, for example, handedness, where digitization of a flat book may offer the ability to tune the reading experience for left handed vs. right handed readers. The elements that may carry special treatment may include: location of annotations, full page notes, search results, social pane, notifications, and button placement on command bars.

Other features may include navigation, activation of commands, selection of menu options, and similar interactions through voice commands, optically captured gestures, gyroscopic input, and eye tracking in addition to touch-based input, keyboard input, pen input, etc. Eye tracking may also be used to highlight or to expand the size of the text being read, and to scroll pages as the eyes move over the content. Eye tracking may further be used to set scroll speed/highlighting for speed reading.

Furthermore, users may be enabled to add annotations to any location within audio or video media elements. As media is consumed, users may pause the audio or video and take a note (ink or otherwise). The e-reader may present these annotations on the play bar for media. Users may also be enabled to jump between annotated locations using the play bar similar to using the snippet directory.

The example scenarios and configurations in FIG. 1 through 4 are shown with specific objects, data types, and configurations. Embodiments are not limited to systems according to these example configurations. Providing flat content to rich content conversion in an e-reader environment may be implemented in configurations employing fewer or additional components in applications and user interfaces. Furthermore, the example schema and components shown in FIG. 1 through 4 and their subcomponents may be implemented in a similar manner with other values using the principles described herein.

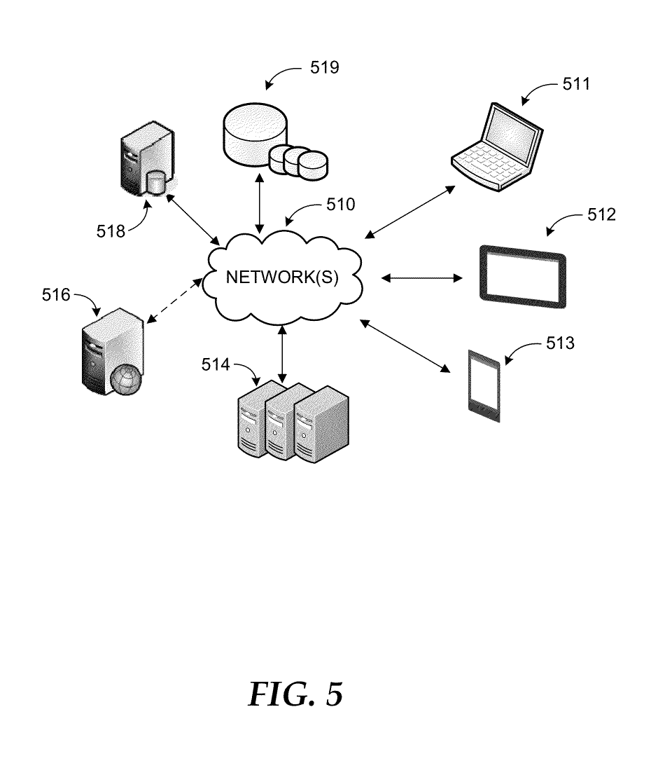

FIG. 5 is a networked environment, where a system according to embodiments may be implemented. Local and remote resources may be provided by one or more servers 514 or a single server (e.g. web server) 516 such as a hosted service. An e-reader application may execute on individual computing devices such as a smart phone 513, a tablet device 512, or a laptop computer 511 (‘client devices’) and communicate with a content resource through network(s) 510.

As discussed above, an e-reader application may provide flat content to rich content conversion in an e-reader environment. Content and/or search information may be used to augment flat content along with additional interactive features to present rich content to the user. Client devices 511-513 may enable access to applications executed on remote server(s) (e.g. one of servers 515) as discussed previously. The server(s) may retrieve or store relevant data from/to data store(s) 519 directly or through database server 518.

Network(s) 510 may comprise any topology of servers, clients, Internet service providers, and communication media. A system according to embodiments may have a static or dynamic topology. Network(s) 510 may include secure networks such as an enterprise network, an unsecure network such as a wireless open network, or the Internet. Network(s) 510 may also coordinate communication over other networks such as Public Switched Telephone Network (PSTN) or cellular networks. Furthermore, network(s) 510 may include short range wireless networks such as Bluetooth or similar ones. Network(s) 510 provide communication between the nodes described herein. By way of example, and not limitation, network(s) 510 may include wireless media such as acoustic, RF, infrared and other wireless media.

Many other configurations of computing devices, applications, data sources, and data distribution systems may be employed to providing flat content to rich content conversion in an e-reader environment. Furthermore, the networked environments discussed in FIG. 5 are for illustration purposes only. Embodiments are not limited to the example applications, modules, or processes.

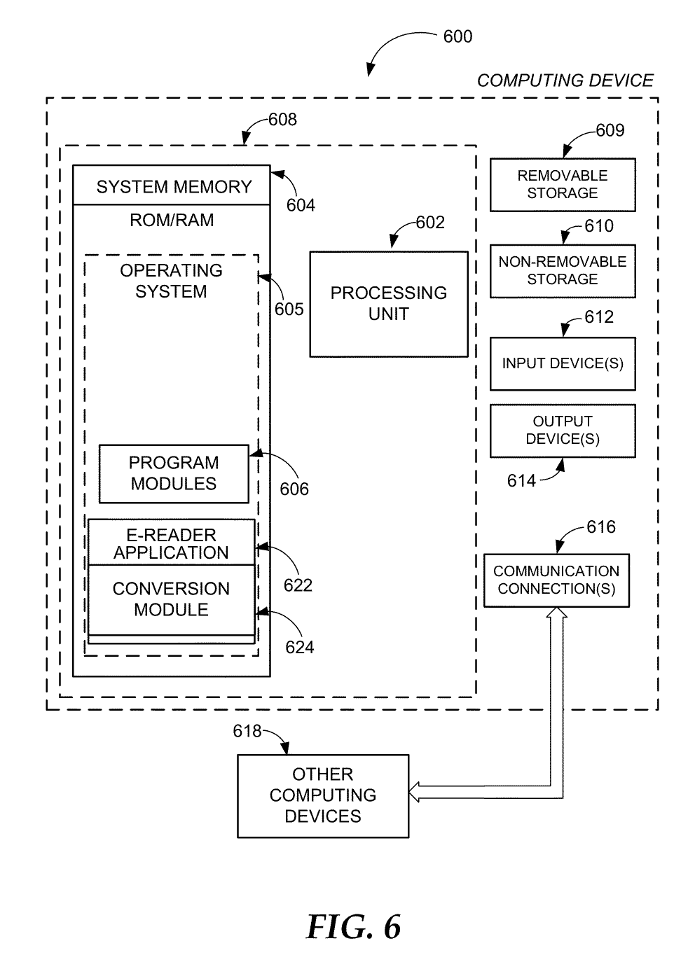

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS° and WINDOWS PHONE® operating systems from MICROSOFT CORPORATION of Redmond, Wash. The system memory 604 may also include one or more software applications such as program modules 606, an e-reader application 622, and a conversion module 624.

An e-reader application 622 may manage content for users presenting rich content created from a flat content source through the conversion module 624 based on key term identification, context-based search, and augmentation of the flat content with search results as well as other enhanced e-reader features. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. Computer readable storage media is a computer readable memory device. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, storage servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be co-located with each other, but each can be only with a machine that performs a portion of the program.

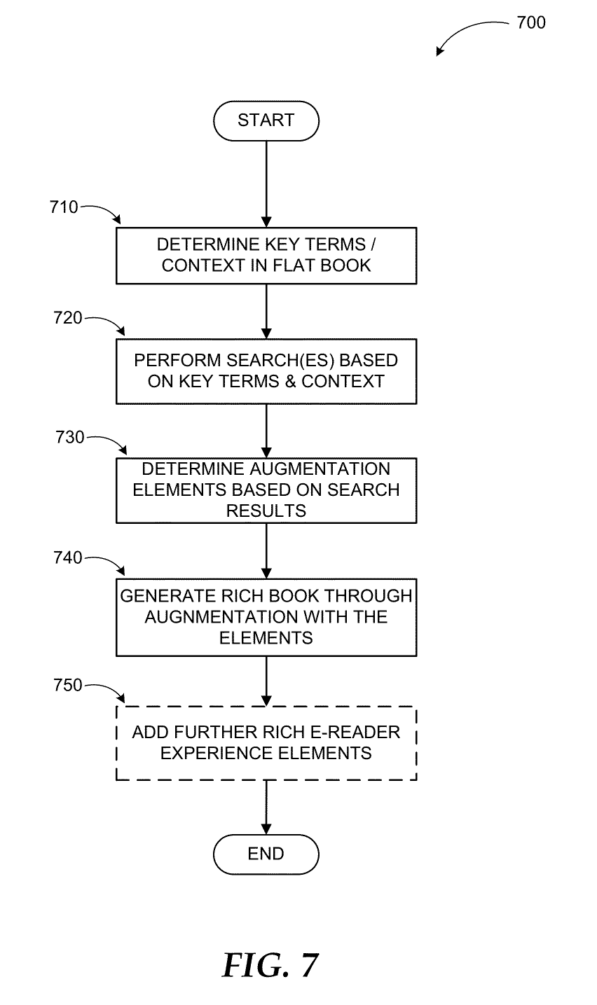

FIG. 7 illustrates a logic flow diagram for a process of converting flat content to rich content in an e-reader environment according to embodiments. Process 700 may be implemented by an e-reader application or service in some examples.

Process 700 may begin with operation 710 where the e-reader application may identify key terms in flat content and context of those terms in relation to the content, a user, a device, and so on. The determined key terms and their context may then be used to perform context-based searches at operation 720 by one or more search engines.

At operation 730, results of the search(es) may be ranked and evaluated against a predefined/customizable threshold. Results that are above the threshold may be selected as augmentation elements for enriching the flat content. Such elements may include textual data, graphics, audio/video data, or other interactable elements (e.g., fill-in objects, script-based objects, etc.). At operation 740, rich content may be generated by augmenting the flat content with the augmentation elements in suitable places (in relation to the content associated to each result).

At optional operation 750, further rich e-reader experience elements may be added such as search capability, note taking capability, sharing capability, and similar ones complementing the content conversion and providing a reader with full experience.

Some embodiments may be implemented in a computing device that includes a communication module, a memory, and a processor, where the processor executes a method as described above or comparable ones in conjunction with instructions stored in the memory. Other embodiments may be implemented as a computer readable storage medium with instructions stored thereon for executing a method as described above or similar ones.

The operations included in process 700 are for illustration purposes. Providing flat content to rich content conversion in an e-reader application, according to embodiments, may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A method executed on a computing device for providing flat content to rich content conversion in an e-reader environment, the method comprising:
identifying key terms in the flat content;
determining a context for the identified key terms;
performing a context-based search for the identified key terms; and
augmenting the flat content based on results of the search to generate the rich content.

2. The method of claim 1, further comprising:
determining one or more augmentation elements by ranking the results of the search and comparing the ranked results to a predefined threshold.

3. The method of claim 2, further comprising:
customizing one or more of the predefined threshold and the augmentation elements based on user preferences.

4. The method of claim 2, wherein the augmentation elements include one or more of: textual data, graphic data, an image, an audio object, a video object, and an interactive object.

5. The method of claim 1, further comprising:
providing one or more interactivity features comprising: inline note taking, inking, snippets selection, snippet based navigation, layout reflow upon device change, and context based search of local and web-based data.

6. The method of claim 1, further comprising:
activating the interactivity features based on one or more of a direct user action on a displayed control element and inference from an indirect user action.

7. The method of claim 1, further comprising:
storing the rich content in a rich e-reader content format that is different from a format of the flat content.

8. The method of claim 1, further comprising:
determining the context from one or more of at least one term within a predefined vicinity of a key term, a title of displayed content, and a type of displayed content.

9. The method of claim 1, further comprising:
ranking the results of the search based on one or more of a default rule and a custom rule.

10. The method of claim 1, further comprising:
determining a user interest from a user attribute; and
selecting the augmentation elements based on the user interest.

11. The method of claim 1, further comprising:
employing a plurality of search engines for performing the search; and
evaluating results from the plurality of search engines.

12. A computing device for providing flat content to rich content conversion in an e-reader environment, the computing device comprising:
a memory configured to store instructions; and
a processor coupled to the memory, the processor executing an e-reader application in conjunction with the instructions stored in the memory, wherein the e-reader application is configured to:
identify key terms in the flat content;
determine a context for the identified key terms;
perform a context-based search for the identified key terms;
determine one or more augmentation elements by ranking the results of the search;
compare the ranked results to a customizable predefined threshold; and
augment the flat content based on results of the search to generate the rich content.

13. The computing device of claim 12, wherein the e-reader application is further configured to:
enable interaction for a user through one or more of a touch input, a gesture input, a mouse input, a keyboard input, a gyroscopic input, and an eye-tracking input.

14. The computing device of claim 12, wherein the computing device is a server providing the e-reader application as a hosted service, and the e-reader application is further configured to:
convert the flat content to the rich content once; and
provide the generated rich content to a plurality of users.

15. The computing device of claim 12, wherein the rich content includes one of an e-book, a magazine article, a newspaper article, professional document, and a personal document.

16. A computer-readable memory device with instructions stored thereon for providing flat content to rich content conversion in an e-reader environment, the instructions comprising:
identifying key terms in the flat content;
determining a context for the identified key terms;
performing a context-based search for the identified key terms;
determining one or more augmentation elements by ranking the results of the search;
comparing the ranked results to a predefined threshold;
augmenting the flat content based on results of the search to generate the rich content; and
providing one or more interactivity features comprising: inline note taking, inking, snippets selection, snippet based navigation, layout reflow upon device change, and context based search of local and web-based data.

17. The computer-readable memory device of claim 16, wherein the instructions further comprise:
employing eye-tracking for one or more of highlighting a portion of displayed content, expanding a size of content being read, scrolling pages, setting a scroll speed, and highlighting text for speed reading.

18. The computer-readable memory device of claim 16, wherein the instructions further comprise:
determining a location of one or more of an annotation, a full page note, a search result, a social pane, a notification, and a search pane based on whether a user is left-handed or right-handed and based on a selected language for the e-reader application.

19. The computer-readable memory device of claim 18, wherein the instructions further comprise:
determining a location and a direction of ink annotations and a placement of one or more controls based on whether a user is left-handed or right-handed and based on a selected language for the e-reader application.

20. The computer-readable memory device of claim 16, wherein the instructions further comprise:
enabling addition of annotations to a selected location within one of an audio and a video content elements augmented into the rich content.
